(19) United States
(12) Patent Application Publication
(10) Pub. No.: US 2026/0205933 A1
(43) Pub. Date: Jul. 16, 2026

(54) Short-range radio network with connectivity parameter

(71) Applicant: ORANGE, Issy-les-Moulineaux (FR)

(72) Inventors: Jean-Michel BONNAMY, Châtillon (FR); Philippe HAMET, Châtillon (FR)

(21) Appl. No.: 19/133,458

(22) PCT Filed: Nov. 22, 2023
(86) PCT No.: PCT/EP2023/082648

§ 371 Date: May 28, 2025

(30) Foreign Application Priority Data
Nov. 29, 2022 (FR) 2212483

(51) Int. Cl. H04W 48/20; H04W 48/16

(52) U.S. Cl. CPC H04W 48/20; H04W 48/16

(57) ABSTRACT

A method for communication between a station and at least a first access point belonging to a short-range radio network identified by a network identifier. The network includes a plurality of access points. The method is implemented by the station and includes: receiving, from the first access point, a message including the network identifier, at least one identifier of a second access point from the plurality of access points and a value of a connectivity parameter of the second access point; selecting, from the plurality of access points, depending on the at least one received value of a connectivity parameter, an access point to which to connect; and establishing a connection with the access point thus selected using its identifier.

### 1. FIELD OF THE INVENTION

The invention relates to the field of communication networks, and more particularly to the field of short-range radio networks such as home or public Wi-Fi networks.

More particularly, the invention relates to the connection of a piece of equipment, referred to as a station, to an access point of a short-range radio network when said station is located in the coverage area of a plurality of access points to the short-range radio network.

### 2. PRIOR ART

One issue with short-range radio networks relates to the selection by a station STA in a roaming situation of an access point APi of a BSS network to which to connect.

Such a BSS network is, for example, a home local area network (or LAN), comprising a gateway GW interfacing this BSS network with an access network of a telecommunication operator. Such a gateway GW is, for example, an ADSL (Asymmetric Digital Subscriber Line) router, a home gateway, an ONT (Optical Network Termination), etc.

In a typical roaming situation, the station receives several beacon messages transmitted periodically by the access points. Such beacon messages are defined in the normative document referenced 802.11 published by the IEEE (Institute of Electrical and Electronics Engineers), thanks to which the station determines a received signal strength indication (RSSI) of the signal transmitted by the various access points APi. The station then selects the access point that transmitted the signal having the highest RSSI and/or the signal-to-noise ratio (SNR) having the highest value.

However, this selection of an access point to which to connect on the basis of the RSSI alone is not satisfactory. Indeed, access points have limited bandwidth resources, in such a way that when several stations connect to a given access point, the effective bitrate of the access point decreases accordingly, without this necessarily resulting in a drop in the RSSI value.

In addition, the links established between access points are most often wireless links. However, for cost reasons, most access points typically only have a single Wi-Fi chipset capable of transmitting and receiving short-range radio signals. The access points are then said to operate in half-duplex mode.

Thus, in this case, an access point cannot simultaneously receive data transmitted by another access point or by a station and transmit data to another access point or to another station. Here again, such an operation mode of the access points is not reflected in a measurement of an RSSI value. A first access point having a higher RSSI value than a second access point can in practice deliver a poorer bitrate, due to its half-duplex operation.

Finally, the topology of the BSS network also has an impact on the bitrate that an access point can deliver. Thus, when the access points are arranged in series or in a daisychain, the further topologically a given access point is from the gateway GW (that is, the greater the number of intermediate access points existing between the access point considered and the gateway GW), the more the bitrate that this access point can provide decreases. However, this effective bitrate is not reflected in the RSSI values. This is particularly true when the links established between the various access points are wireless links (for example, Wi-Fi links).

To overcome this problem of the RSSI not being representative of the bitrate effectively provided by an access point, the normative document referenced 802.11v published by the IEEE introduces the principle of “steering”, according to which one or more access points transmit a request to a station asking it to switch from a first access point AP1 to a second access point AP2 (this is known as “client steering”) or from one frequency band (for example, for Wi-Fi, the 2.4 GHz band and the 5 GHz band or the 6 GHz band) to another (this is known as band steering). These roaming requests are transmitted in BTM (BSS Transition Management) messages defined in the normative document referenced 802.11v.

However, stations receiving such roaming requests are free to remain connected to the access point of their choice. Thus, a station can connect (or remain connected) to a given access point even if this degrades the quality of service of the entire network (i.e. of the other access points) and of the stations already connected. Thus, a station receiving a roaming request from the first access point AP1 to the second access point AP2 can decide to switch to the second access point AP2, to ignore the request and remain connected to the first access point AP1 or to refuse to change access point.

In addition, even in the case where the station decides to connect to another access point, many stations decide shortly after this switch to this new access point AP2 to return to the first access point AP1 to which they were previously connected, even if, from a quality of service point of view, this choice is not optimal. A back-and-forth, or “ping pong”, between the request from the network to switch to the access point AP2 and the choice from the station to reconnect to the access point AP1 follows. This can have a negative impact on the user experience, depending on the type of service implemented during this back-and-forth, for example for real-time services such as a VoWi-Fi (Voice over Wi-Fi) service, a videoconferencing service or a document sharing service. In addition to this back-and-forth between stations phenomenon, steering (client steering or band steering) does not avoid the potential accumulation of stations all connecting to the same access point.

The invention aims to improve some or all of the above-mentioned disadvantages.

### 3. SUMMARY OF THE INVENTION

To this end, the invention proposes a method for communication between a station and at least a first access point belonging to a short-range radio network identified by a network identifier, said network comprising a plurality of access points,
the method being implemented by the station and comprising:
receiving, from said first access point, a message comprising the network identifier, at least one identifier of a second access point from the plurality of access points and a value of a connectivity parameter of said second access point,
selecting, from the plurality of access points, depending on the at least one connectivity parameter value received, an access point to which to connect, and
establishing a connection with said access point thus selected using its identifier.

Thus, the station can select the access point to which to connect using a connectivity parameter representative of the connectivity that a given access point can provide, and not just using a piece of information representative of a received signal quality such as RSSI or SNR.

It is understood that, in certain cases, the first access point and the second access point can refer to the same access point.

The connectivity of an access point is understood as what this access point can provide in terms of quality of service, bitrate, latency, etc. It is thus understood that the value of the connectivity parameter associated with an access point represents, in a single value, the quality of the connectivity that this access point can provide.

As will be described below, this value of the connectivity parameter can thus be used to synthesise in a single value various information about the short-range radio network and its current use, for example synthesise in a single value the number of stations already connected to the access point, the topology of the network (for example the number of link(s) between the access point and the gateway), the nature of the links between access points (Ethernet or Wi-Fi, dual-band or tri-band, number of transmission channels, . . . ), . . . .

The overall quality of service of the BSS network the station receives is thus improved, because the station no longer connects only according to the proximity to an access point, but according to a connectivity level that an access point can effectively provide.

Moreover, this method limits the above-mentioned back-and-forth effect, as there is less “conflict” between a roaming request to a first access point and RSSI measurements indicating that a second access point would be a better choice.

Finally, the station implementing this method can select the access point to which to connect by having both information on the station side, i.e. the RSSI of potential access points to which to connect, and on the network side, since the station has a piece of information relating to the connectivity of these potential access points.

According to a particular characteristic, said message is a beacon message from said first access point.

Here, the station is aware of the value of connectivity parameters of the access points from which it receives the beacon messages. This gives beacon messages a dual purpose in choosing the access point to which to connect, since a beacon message not only allows the station to measure a value of the RSSI of an access point, but also to obtain the value of the connectivity parameter of an access point comprised in the beacon message. Thus, this avoids transmitting additional messages to provide a connectivity parameter to the station.

According to a particular characteristic, the method further comprises, prior to receiving said message from said access point comprising the at least one connectivity parameter, transmitting a probe request to the access points of the network.

Thus, the station receives one or more connectivity parameter values on request, which enables it to select the access point to which to connect. For example, the station can transmit such requests as soon as the quality of service it receives is no longer satisfactory, or at regular time intervals, typically when the station is in motion and a degradation of the signal received from an access point (and therefore of the RSSI) is predictable.

According to a particular characteristic, the access point to which to connect is further selected depending on an RSSI value measured by said station.

Thus, the station also takes into account the RSSI value(s) it measures when selecting the access point to which to connect. In fact, the access point selected and with which the station establishes a connection is both more relevant from a connectivity point of view and also from a received signal quality point of view.

The invention also proposes a method for transmitting at least one message to at least one station, said message being transmitted by a first access point belonging to a short-range radio network identified by a network identifier, said network comprising a plurality of access points, the method being implemented by the first access point and comprising:
obtaining at least one identifier (ID_APk) of a second access point from the plurality of access points and a value of a connectivity parameter of said second access point,
transmitting, to the station, said message comprising the network identifier, at least said identifier of said second access point (APk) and the at least one value of the connectivity parameter of said second access point thus obtained.

This transmission method, mirroring the communication method implemented on the station side, enables an access point to provide information relating to its connectivity, via the value of the connectivity parameter it transmits.

It is understood that, in certain cases, the first access point and the second access point can refer to the same access point.

This allows an access point having poor connectivity, for example when many stations already have established a link with it, or when its link with the gateway has a low bitrate or a high latency, to signal this fact to the stations concerned, so that they can select another access point to which to connect.

Conversely, an access point having good connectivity can signal itself as such, i.e. with a high connectivity parameter value, so as to encourage stations to connect and offload other access points.

The network load is then better distributed, and bottleneck or back-and-forth phenomena are limited.

According to a particular characteristic, said message is a beacon message.

The access point can thus communicate its connectivity parameter within a beacon message. It results in a slight increase in the workload of an access point, while still benefiting from the advantages described above.

According to a particular characteristic, the method further comprises receiving a probe request from the station,
said reception of the probe request triggering the transmission of said message in the form of a probe response.

The invention also proposes a method for determining at least one connectivity parameter of an access point belonging to a short-range radio network identified by a network identifier, said network comprising a plurality of access points, said method being implemented by a controller belonging to said network and comprising:
determining, for at least a first access point from the plurality of access points, a value of a connectivity parameter depending on at least one piece of information representative of at least one link established between said first access point and another access point from the plurality of access points,
transmitting, to at least one of said access points of said network, the value of the connectivity parameter of an access point thus determined.

Thus, the value of the connectivity parameter of an access point depends on the arrangement of the network, and in particular on the nature of the links between access points. In other words, thanks to this determination method, it is possible to synthesise in a value of the connectivity parameter associated with an access point the quality of the connectivity that this access point can provide, taking into account various information about the short-range radio network.

According to a particular characteristic of this determination method, the piece of information representative of at least one link belongs to the group of information comprising: a piece of information about the topology of the network, a piece of information about the nature of said link, a latency between access points and an effective bitrate that can be provided by said access point of the connectivity parameter.

Thus, this connectivity parameter value can depend on the structure of the network itself (its graph, for example), the nature of the links established between the access points, or even metrics related to the effective quality of service that an access point can provide.

The invention also relates to a station capable of communicating with at least a first access point belonging to a short-range radio network identified by a network identifier, said network 5 comprising a plurality of access points,
the station comprising a processor configured to:
receive, from said first access point, a message comprising the network identifier, at least one identifier (AP_IDk) of a second access point (APk) from the plurality of access points and a value of a connectivity parameter of said second access point,
select, from the plurality of access points, depending on the at least one received value of a connectivity parameter, an access point to which to connect, and
establish a connection with said access point thus selected using its identifier.

The invention also relates to an access point belonging to a short-range radio network identified by a network identifier, said network comprising a plurality of access points, the access point being able to communicate with at least one station,
the access point comprising a processor configured to:
obtain at least one identifier (ID_APk) of a second access point from the plurality of access points and a value of a connectivity parameter of said second access point of said network,
transmit, to the station, a message comprising the network identifier, at least said identifier of said second access point (APk) and the at least one value of the connectivity parameter of said second access point thus obtained.

The invention further relates to a controller belonging to a short-range radio network identified by a network identifier, said network comprising a plurality of access points,
the controller comprising a processor configured to:
determine, for at least a first access point from the plurality of access points, a value of a connectivity parameter depending on at least one piece of information representative of at least one link established between said first access point and another access point from the plurality of access points,
transmit, to at least one of said access points from the plurality of access points, the value of the connectivity parameter of an access point thus determined.

According to a particular characteristic, the controller is embedded in said first access point of the network.

Thus, the implementation of the determination method within said access point-whose connectivity parameter value is determined-enables the access point and the controller to be pooled into the same piece of equipment. Moreover, this distributes the determination of connectivity parameter values between various access points, in a decentralised way.

The invention also relates to a computer program product comprising program code instructions for implementing one of the methods described above, when this program is executed by a computer.

### 4. LIST OF FIGURES

Other characteristics and advantages of the invention will emerge more clearly upon reading the following description of a particular embodiment, provided as a simple illustrative non-restrictive example, and the annexed drawings, wherein:

FIG. 1 shows an example of a short-range radio network;

FIG. 2 shows a first embodiment of a communication method according to the invention, implemented in the BSS network of FIG. 1;

FIG. 3 shows a second embodiment of a communication method according to the invention, implemented in the BSS network of FIG. 1;

FIG. 4 shows an example of a connectivity parameter determination method according to the invention, implemented in the BSS network of FIG. 1;

FIG. 5 shows another example of a “star” short-range radio network;

FIG. 6 shows a simplified structure of a station of the network of FIG. 1;

FIG. 7 shows a simplified structure of an access point of the network of FIG. 1;

FIG. 8 shows a simplified structure of a controller of the network of FIG. 1.

### 5. DESCRIPTION OF THE EMBODIMENTS OF THE INVENTION

### 5.1. BSS Network

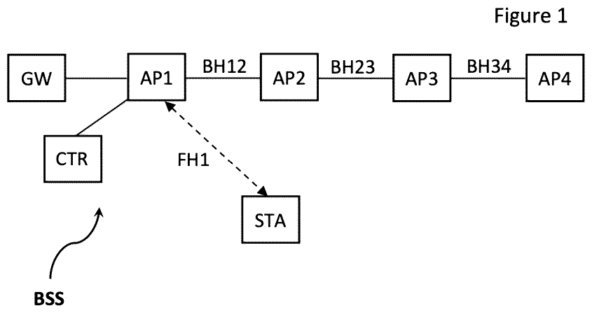

Reference is made to FIG. 1, showing an example of a short-range radio network, such as a Wi-Fi network, referred to as a BSS network. Such a short-range radio network, referred to as BSS (“basic service set”), is shown in FIG. 1. This BSS network can be accessed by at least one piece of terminal equipment, referred to as a station STA. Such a station is, for example, a personal computer, a tablet, a smartphone, a connected object, a smart sensor, etc.

Given the short range of these waves (from a few metres to a few tens of metres), such a BSS network can comprise a plurality of access points (noted AP) APi, where i is an integer (here, four access points AP1, . . . , AP4) to the BSS network so to extend its coverage—these are known as repeaters or extenders. These access points APi are connected to each other by means of links noted BHij where i and j are integers corresponding to the access points constituting the ends of these links, for example BH12 is the link connecting the access point AP1 to the access point AP2. All access points APi share the same SSID (“Service Set Identifier”) network identifier identifying the BSS network. Thus, a station STA can connect to the BSS network via any one of the access points APi by means of a short-range radio wave connection. An access point APi is, for example, embedded in a home gateway or in a public access device to a wireless network, more commonly referred to as a “hotspot”.

In the remainder of the application, letters i, j, k and m will be used as integer indexes of various access points. These access points are connected to each other by links noted BHij, i and j identifying the two access points APi and APj constituting the ends of said link BHij.

The BSS network can further comprise a gateway GW interfacing the BSS network with another network such as an access network. The gateway GW is connected to one of the access points, here the access point AP1. The BSS network is identified by an SSID network identifier, possessed by all access points belonging to the BSS network

By way of example, the BSS network can be a home local network (LAN), and the gateway is the piece of equipment that interconnects the BSS network with an access network of a telecommunication operator. This piece of equipment can be either an ADSL router, a cable modem or an optical network termination (ONT).

Still by way of example, the access network can be a wired access network of the xDSL (“Digital Subscriber Line”) type, of the optical type such as an xPON (Passive Optical Network), of the cable type. As a variant, the access network can be a radio access network or RAN compliant with the second to sixth generation communication standard.

The BSS network finally comprises a module referred to as a controller. This controller CTR can be embedded in the gateway GW, in an access point or in a distinct piece of equipment. As a variant, the network can comprise several controllers CTR.

By way of example, the gateway GW can be embedded in a device such as a box, further embedding the controller CTR as well as optionally an access point.

The BSS network can be for example a home Wi-Fi network, or a public Wi-Fi network.

A station STA connects to the BSS network via an access point APi of the BSS network, by means of a link noted FHi (where i is the index of the access point to which the station STA connects). The link FHi is a wireless link such as, for example, a Wi-Fi link. In the example shown in FIG. 1, the station STA is thus connected to the access AP1 point by means of the link FH1.

Thus, when it is located in the coverage area of several access points, the station STA can connect to any of these access points. However, the classic criterion for selecting an access point with which to establish a link is the highest RSSI value and/or the highest SNR value. This leads to a sub-optimal choice in terms of connectivity (quality of service, bitrate, latency, etc.), when two access points for which the station STA has measured close RSSI values offer very different connectivities.

For example, assuming that the access point AP1 serves no stations and the access point AP2 serves around ten, and that the access point AP2 has an RSSI value greater than the RSSI value of the access point AP1, then the station STA can still connect to the access point AP2, even though the access point AP1 may be much more advantageous from a connectivity point of view.

To overcome this problem, the general principle of the invention is to communicate to the station STA an indicator, hereinafter referred to as a connectivity parameter and noted PCi (where i is the index of an access point APi), representative of the connectivity of an access point. The station STA can then select the access point to which to connect using this connectivity parameter.

The connectivity of an access point means is understood, as mentioned previously, as what this access point can provide in terms of quality of service, bitrate, latency, etc. In some cases, the station STA has the connectivity parameters of several access points, and can select the access point with which to establish a connection according to a given criterion, for example the access point having the highest value for the connectivity parameter. The station STA can also use one or more RSSI values, to select an access point with which to establish a connection that is a good compromise between a quality of service that the access point can provide, represented by the connectivity parameter, and the quality of the radio signal that the station STA receives from this access point, represented by the RSSI value or the SNR value.

Thus, the station STA has an additional piece of information, the connectivity parameter, to select the access point to which to connect.

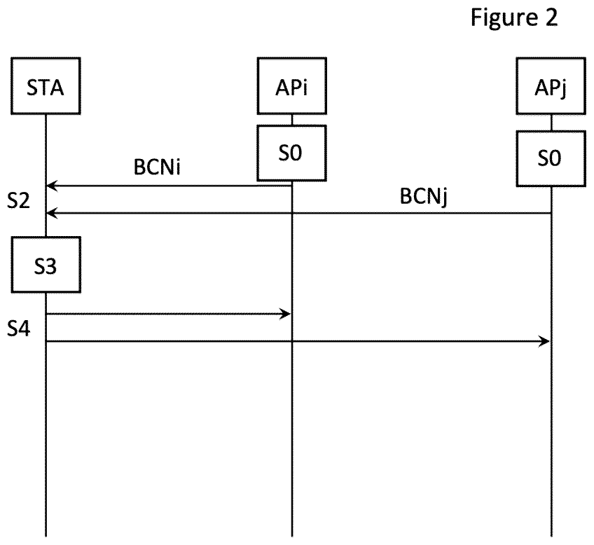

Reference is now made to FIG. 2, that shows a first embodiment of the invention.

In a step S0, at least one of the access points APi of the BSS network obtains at least one value of a connectivity parameter PCk of one of the access points APk of the network. The value of the connectivity parameter PCk thus obtained by the access point APi is not necessarily that of its own connectivity parameter PCi.

In a step S2, the access point APi transmits a message BCNi comprising its identifier ID_APi, the value of the connectivity parameter PCk obtained in step S0, the SSID identifier of the BSS network. In the case where k≠i, the message BCNi further comprises an identifier AP_IDk of the access point APk to which the connectivity parameter PCk corresponds. Similarly, another access point APj can transmit a message BCNj comprising its access point identifier ID_APj, the SSID identifier of the BSS network and at least one connectivity parameter PCm. In the case where m≠j, the message BCNj further comprises the identifier ID_APm of the access point APm to which the connectivity parameter PCm contained in the message BCNj corresponds.

In a step S3, a station STA that has received the message BCNi transmitted by the access point APi selects, depending on the at least one received value of a connectivity parameter PCk, an access point APk, k ranging in this example from 1 to 4, to which to connect. Various examples of criteria for selecting the access point depending on the connectivity parameter(s) thus received are described below.

In a step S4, the station STA then establishes a connection with said access point APm thus selected.

In the example shown in FIG. 2, the station STA receives the identifiers ID_APi, ID_APj and the corresponding connectivity parameters PCi, PCj, and selects either the access point APi or the access point APj, depending on the connectivity parameters PCi and PCj received.

Thus, the station STA has additional information enabling it to select the access point to which to connect, using a connectivity parameter representative of the connectivity that a given access point can provide—for example, a quality of service, a bitrate, a latency, and not just using a single metric relating to the quality of the signal received, such as RSSI or SNR.

In the case where the station STA receives values of several connectivity parameters PCi, the station STA can select the access point to which to connect by comparing the values of the connectivity parameters received.

In the case where the station STA receives the value of only one connectivity parameter PCi, the station STA can select the access point to which to connect depending on one or more RSSI values determined for one or more access points, and the connectivity parameter PCi received. The station STA can, for example, give preference to the access point whose connectivity parameter PCi has been received when its value exceeds a certain threshold—representative of a certain connectivity offered—and the RSSI value measured for this access point exceeds a certain threshold-representative of a certain signal strength received—and otherwise the access point with the best RSSI.

### 5.2. Beacon Mode

In one embodiment, each of the access points APi transmits a beacon message BCNi at regular time intervals. This beacon message comprises the SSID identifier of the network as well as the identifier AP_IDi of the access point APi. This identifier AP_IDi of the access point APi can, for example, be a physical address, such as a MAC (“Medium Access Control”) address. This beacon message BCNi is used by the station STA capturing the radio signal carrying it to determine an RSSI value for the access point APi.

In addition to this information, the beacon message BCNi comprises a connectivity parameter PCj value.

In one embodiment, the connectivity parameter whose value is included in the beacon message BCNi is the connectivity parameter PCi of the access point APi. Thus, here, each access point APi regularly transmits a beacon message BCNi comprising the value of its connectivity parameter PCi, its identifier AP_IDi and the SSID identifier of the network to which it belongs, in such a way that the station is aware of all the connectivity parameters PCi of the access points APi whose beacon messages BCNi it captures.

In another embodiment, the beacon message BCNi transmitted by an access point APi comprises information relating to n distinct access points APi in the form of n pairs (AP_IDi, PCi) each comprising an identifier AP_IDi of an access point and the corresponding value of its connectivity parameter PCi. Thus, the station can select an access point to which to connect using a single beacon message. The number n of pairs comprised in the beacon message can be equal to the number N_AP of access points of the BSS network. As a variant, only a certain number of pairs are comprised in the beacon message, for example the n pairs having the highest connectivity parameter value.

As explained above, the beacon messages are transmitted at regular time intervals, which can be defined for example by a TBTT (Target Beacon Transmission Time) parameter.

### 5.3. Probe/Response Mode

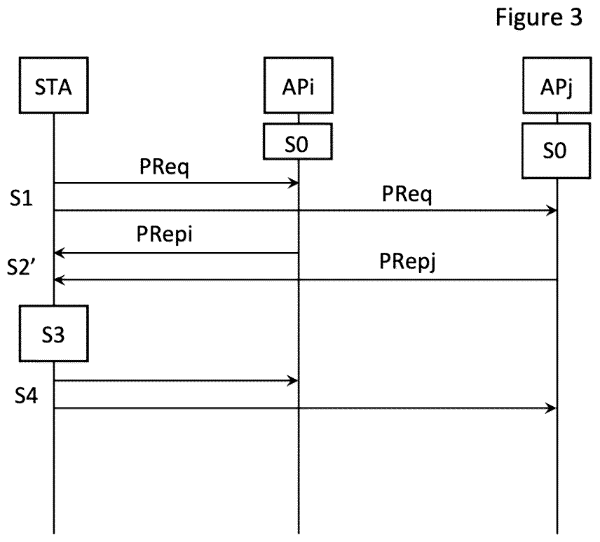

Reference is made to FIG. 3, that shows another embodiment of the method described above. Steps S3 and S4 of the method of FIG. 3 are identical to steps S3 and S4 of the method shown by FIG. 2.

In this other embodiment, compliant with the first one, one or more connectivity parameters are obtained via a probe request/probe response exchange between the station STA and an access point.

Here, in a step S1, the station STA sends a probe request PReq, meaning that the station STA wants to obtain information about the connectivity of the access points before selecting one to which to connect. The probe request can be transmitted to a specific access point, for example an access point whose station receives a beacon message, or it can be broadcast, all the access points located near the station STA being then likely to receive said probe request PReq.

In a step S2′, the station STA receives a probe response PRepi from at least one access point APi. This probe response PRepi comprises at least one value of a connectivity parameter PCi, the SSID identifier of the BSS network and an access point identifier AP_IDk.

More particularly, the probe response PRepi transmitted by the access point APi comprises the identifier AP_IDi of this access point, the value of the connectivity parameter PCi of this access point, and the SSID identifier of the BSS network.

Here, the access points that have received the probe request can send back their own identifier and connectivity parameter, which reduces the amount of data exchanged, since each access point only needs to transmit to the station information relating to its own connectivity.

The probe response here may not be transmitted automatically in response to the receipt of a probe request, and can be at the discretion of an access point that can choose not to return its connectivity parameter, for example if the access point considers its load to be too high—i.e. too many stations having already established a link with it, or a station already consuming a lot of bandwidth, resulting, for example, in a low connectivity parameter PCi value.

According to another example, the probe response PRepi comprises n pairs (AP_IDi, PCi) for n distinct access points APi, each pair comprising an identifier AP_IDi of an access point and the corresponding value of its connectivity parameter PCi. The number n of pairs can be less than or equal to the number of access points for the reasons described above. This allows all or part of the connectivity parameters to be fed back in a single probe response PRepi.

### 5.4. Determining the Connectivity Parameter

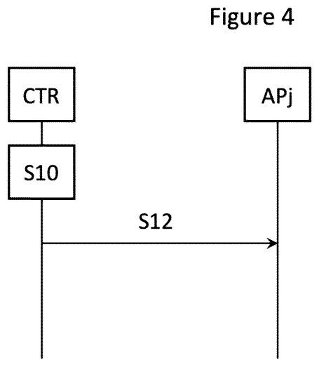

The exchanges between the station STA and one or more access points enabling the latter to obtain one or more values of connectivity parameters relating to one or more access points have been described so far. Reference is now made to FIG. 4, that shows a method for determining the values of the connectivity parameters PCi of the access points. This method is implemented by the controller CTR. As a variant, the BSS network can comprise several controllers, as described above.

This method comprises a step S10 of determining a value of a connectivity parameter PCi of a first access point APi, and a step S12 of transmitting this value thus determined to another access point APj, this other access point APj possibly being the first access point APi or a different access point.

Said value of the connectivity parameter PCi is determined depending on at least one piece of information representative of at least one link BHij established between said first access point APi and at least one second access point APj of the BSS network.

The arrangement of the network access points, or topology of the BSS network, defines a graph of the BSS network, the nodes of said graph being the access points and the edges of said graph being the links connecting two access points together. In the example shown in FIG. 1, the access points are connected in series, that is, a given access point is connected to at most two other access points.

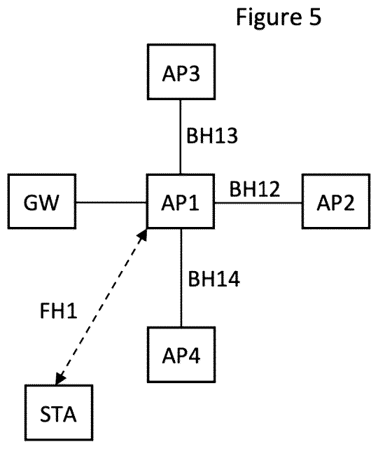

Alternatively, the access points can be arranged in a star shape around a central access point, the graph is then known to be a “star” graph, as for the network shown in FIG. 5, or arranged in a mesh. The network graph can, of course, be a combination of these various BSS network topologies, the only constraint on this graph being that it must be connected (i.e. in one piece).

The inventors have observed that the topology of the BSS network is a relevant factor to determine a connectivity parameter PCi. Hereinafter, the BSS network graph is considered to be acyclic, or, in other words, as a tree, whose root is the access point AP1 closest to the gateway GW. The terms parent access point and child access point in the sense of the graph theory will be used hereinafter-since an access point is a node in the BSS network tree, a parent access point being closer to the root than a child node, and the terms BSS network tree and BSS network graph will be used interchangeably below.

Thus, in a first embodiment, the connectivity parameter PCi is a function of the distance of the access point APi from the gateway GW. The further away the access point APi is, that is the greater the number of intermediate access points APi existing between the access point considered and the gateway GW, the lower the value of the connectivity parameter PCi.

For example, the value of the connectivity parameter PCi can be calculated using the formula PCi=100/(1+N_BH), where N_BH represents the number of links between the access point APi and the gateway GW. In the example shown in FIG. 1, the connectivity parameters PCi are respectively 100 for the access point AP1 (N_BH=0), 50 for the access point AP2 (N_BH=1), 33.3 for the access point AP3 (N_BH=2) and 25 for the access point AP4 (N_BH=3).

This choice to count the number of links between access points is particularly relevant when the access points communicate with each other in “half-duplex” mode by means of wireless links. Indeed, in this case, the further an access point is from the gateway GW, the more its connectivity depends on how the bandwidth is used by the intermediate access points located between it and the gateway. Similarly, the wireless nature of the links has an impact on their connectivity. Indeed, a wireless link is by nature more sensitive to electromagnetic disturbances, and the data transmitted by means of these links is more prone to loss.

This formula PCi=100/(1+N_BH) can be generalised as PCi=f (N_BH) where f is a decreasing function. Thus, the determination of the connectivity parameter PCi value takes into account the network topology—for example, the number of links between the gateway GW and the access point APi whose connectivity parameter PCi value the controller is seeking to determine.

In the case of a non-serial network topology, the function f above can take into account other topological parameters relating to branches of the BSS network tree to which the access point APi does not belong, for example so that the value of the connectivity parameter APi of the access point PCi obtained reflects the impact of other access points sharing the same parent access point as the access point APi on the connectivity of the access point APi concerned. In the case of a mesh (or cyclic graph), the function f is even different.

In a second embodiment, the connectivity parameter PCi takes into account not only the number of links existing between the access point APi and the gateway, but also their nature. Indeed, Ethernet links, more generally wired links, are more reliable than Wi-Fi links in terms of packet loss, sensitivity to electromagnetic waves . . . . In addition, when an access point is connected to its neighbouring access points by means of a wired link, it retains all the radio resources available to it to communicate with the stations to which it is connected.

Thus, each link BHij is assigned here a weight bh_type, ranging for example from 0 to 1, representative of the nature of this link. For example, for a link BHij of the Ethernet type bh_type=1, for a link of the tri-band Wi-Fi type bh_type=0.9, for dual-band Wi-Fi bh_type=0.3, etc. These weights are given here for illustrative purposes, the underlying idea being that the closer to 1 they are, the more the corresponding links are likely to transmit data without degrading the connectivity of the access points.

In this case, the value of the connectivity parameter PCi of an access point APi can be defined according to the formula PCi=PCj*bh_type_ij where PCj is the connectivity parameter of the parent access point APj of the access point APi (in the sense of the tree forming the BSS network graph).

Thus, an access point connected to its parent access point by an Ethernet link has the same connectivity as its parent access point. On the contrary, not only an access point connected via a dual-band Wi-Fi link to its parent access point has a lower connectivity parameter value than its parent access point, but this also has an impact on the connectivity of its child access points.

The types of links connecting two access points together can be Ethernet, dual-band Wi-Fi, tri-band Wi-Fi, PLC (power-line communication), home PNA (“Home Phoneline Networking Alliance”), coaxial links (MOCA, for “Multimedia over Coax Alliance”), plastic optical fibre (POF), optical fibre . . . .

In a third embodiment, the calculation of the connectivity parameter PCi of an access point APi also takes into account the number of transmission channels or “spatial streams” of the access point when the latter is equipped with a plurality of transmission antennas.

Here, the value of the connectivity parameter PCi is given by the following formula:

$$PCi = PCj * bh\_type \_ij * ( 1 - 1 / min ( NSS\_APi \_BHij , NSS\_APi \_BHik ) )$$

where j is the index of the parent access point of APi, and k is the index of a child access point APK of APi; and where NSS_APi is the number of spatial streams NSS of the access point APi.

In this embodiment, the nature of the link BHij is further specified, not only its type but also a parameter NSS_APi_BHij representative of its performance, both for communicating with other access points and also for communicating with stations with which it is connected. The number of spatial streams NSS provides an approximation of the bandwidth available for the link BHij.

In another embodiment, the determination of the connectivity parameter PCi can take into account:
a piece of information representative of the effective bitrate that can be provided by the access point APi, or an effective bitrate between said access point APi and the gateway GW, or between the root access point AP1 of the BSS network and said access point APi,
a piece of information representative of a latency measured between the access point APi and the gateway GW or between the root access point AP1 of the BSS network and the access point APi.

The method for determining a connectivity parameter has been described as implemented by the controller CTR. However, it is conceivable to decentralise the determination of connectivity parameters PCi values, each access point APi being able, for example, to receive the value of the parameter PCj of its parent access point APj and, knowing the nature of their link, deduce its own connectivity parameter PCi value.

Thus, the connectivity parameter of an access point is determined within the short-range radio network. This allows to provide only one piece of connectivity information to a station that wants to connect to the network, rather than a multiplicity of pieces of information about the entire short-range radio network. Exchanges between the station and the access point(s) are lighter. In addition, this allows the short-range radio network (in particular the controller) to have control over its policy for distributing the connection of stations to the access points of the short-range radio network, by having control over the connectivity parameter values transmitted.

Optionally, a single connectivity parameter value is determined per access point.

### 5.5. Selection Criteria

The station STA selects in step S3 the access point to which to connect, on the basis of one or more connectivity parameters PCi received.

This selection is made on the basis of a selection criterion, which can be one of the following criteria:
select the access point whose connectivity parameter PCi has the highest value among the values of the connectivity parameters PCi received (criterion of the highest connectivity parameter value),
select the access point whose RSSI value is the highest among access points whose connectivity parameter value exceeds a given threshold (criterion of the highest RSSI among the access points having at least a certain connectivity),
select the access point whose connectivity parameter value is the highest among the access points whose RSSI value measured by the station exceeds a given threshold (criterion of the best connectivity among the access points having at least a certain RSSI value),
randomly select an access point among access points whose connectivity parameter value exceeds a first threshold and whose RSSI value exceeds a second threshold (criterion of random choice among the access points having at least a certain connectivity and at least a certain RSSI value),
select an access point according to the criterion of the highest RSSI value when no value of the connectivity parameters received exceeds a certain threshold (criterion of the best signal quality if no access point exceeds a certain quality of service).

These examples are proposed here for illustrative and non-restrictive purposes, it is, of course, possible to combine a criterion relating to the connectivity parameter with a criterion relating to another indicator (either RSSI, SNR or another criterion).

Connectivity parameters can be determined at regular intervals. For example, the controller can determine these connectivity parameters every minute, every second or every n millisecond.

Connectivity parameters can also be determined when a particular event occurs, such as the failure of an access point or the addition/removal of an access point to/from the network.

A connectivity parameter has been described whose value is all the higher, the greater the connectivity of the access point. It is possible as a variant to define a connectivity parameter whose value is all the lower, the greater the connectivity of the access point. In this case, the station selects the access point by favouring low connectivity parameter values.

A determined connectivity parameter can be transmitted to all the access points-which therefore have a connectivity “map” of all the access points of the network- or only to the access point it corresponds to if when this access point is not already implementing the determination of its own connectivity parameter. This connectivity parameter can also be transmitted to another access point at the request of the latter.

### 6. DEVICES

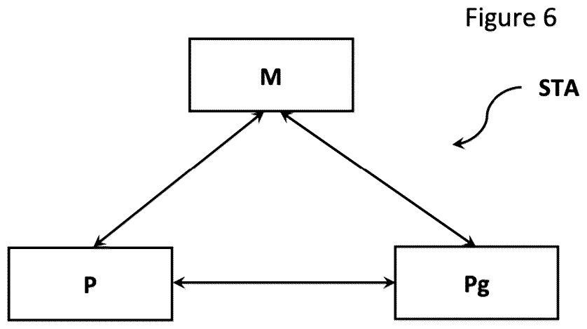

As illustrated in FIG. 6, a station STA according to one embodiment of the invention comprises a memory M, a processing unit, equipped for example with a programmable computing machine or a dedicated computing machine, for example a processor P, and executing the computer program Pg, implementing steps of the communication method according to at least one embodiment of the invention.

At initialisation, the code instructions of the computer program Pg are for example loaded into a RAM memory before being executed by the processor of the processing unit P.

The processor of the processing unit P implements steps of the communication method previously described, according to the instructions of the computer program Pg.

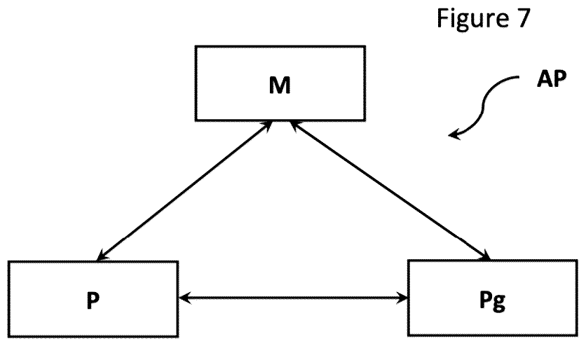

As illustrated in FIG. 7, an access point AP according to one embodiment of the invention comprises a memory M, a processing unit, equipped for example with a programmable computing machine or a dedicated computing machine, for example a processor P, and executing the computer program Pg, implementing steps of the communication method according to at least one embodiment of the invention.

At initialisation, the code instructions of the computer program Pg are for example loaded into a RAM memory before being executed by the processor of the processing unit P.

The processor of the processing unit P implements steps of the communication method previously described, according to the instructions of the computer program Pg.

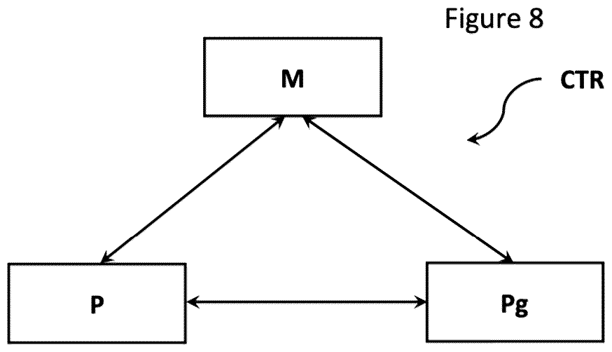

As illustrated in FIG. 8, a controller CTR according to one embodiment of the invention comprises a memory M, a processing unit, equipped for example with a programmable computing machine or a dedicated computing machine, for example a processor P, and executing the computer program Pg, implementing steps of the communication method according to at least one embodiment of the invention.

At initialisation, the code instructions of the computer program Pg are for example loaded into a RAM memory before being executed by the processor of the processing unit P.

The processor of the processing unit P implements steps of the communication method previously described, according to the instructions of the computer program Pg.

A distinct controller CTR and access AP point have been described. In one embodiment of the invention, these two players of the BSS network are implemented within the same device, for example a “box” device embedding the gateway GW, the controller CTR and one of the access points.

1. A method for communication between a station and at least a first access point belonging to a short-range radio network (BSS) identified by a network identifier, said network comprising a plurality of access points,
the method being implemented by the station and comprising:
receiving, from said first access point, a message comprising the network identifier, and at least one value of a connectivity parameter of a second access point from the plurality of access points;
selecting, from the plurality of access points, depending on the at least one received value of a connectivity parameter, an access point to which to connect; and
establishing a connection with said access point thus selected.

2. The method according to claim 1, according to which said message is a beacon message from said first access point.

3. The method according to claim 1, further comprising, prior to receiving said message from said access point comprising the at least one connectivity parameter,
transmitting a probe request to the access points of the network.

4. The method according to claim 1, according to which the access point to which to connect is further selected depending on an RSSI value measured by said station.

5. A method for transmitting at least one message to at least one station, said message being transmitted by a first access point from a plurality of access points belonging to a short-range radio network (BSS) identified by a network identifier,
the method being implemented by the first access point and comprising:
obtaining at least one value of a connectivity parameter of a second access point from the plurality of access points; and
transmitting, to the station, said message comprising the network identifier, at least the value of the connectivity parameter of said second access point thus obtained.

6. The method according to claim 5, wherein said message is a beacon message.

7. The method according to claim 5, further comprising receiving, from the station, a probe request,
said reception of the probe request triggering the transmission of said message in the form of a probe response.

8. A method for determining at least one connectivity parameter of an access point from a plurality of access points belonging to a short-range radio network identified by a network identifier, said method being implemented by a controller belonging to said network and comprising:
determining, for at least the access point, a value of a connectivity parameter depending on at least one piece of information representative of at least one link established between said access point and a second access point from the plurality of access points; and
transmitting, to at least one of said access points of the plurality of access points of said network, the value of the connectivity parameter of said access point thus determined.

9. The method according to claim 8, wherein the piece of information representative of at least one link belongs to the group of information consisting of: a piece of information about the topology of the network, a piece of information about the nature of said link, a latency between access points (APi, APj) and an effective bitrate that can be provided by said access point (APi, APj) of the connectivity parameter (PCi, PCj).

10. A station capable of communicating with at least a first access point from a plurality of access points belonging to a short-range radio network identified by a network identifier,
the station comprising a processor configured to:
receive, from said first access point, a message comprising the network identifier, at least one value of a connectivity parameter of a second access point from the plurality of access points;
select, from the plurality of access points, depending on the at least one received value of a connectivity parameter, an access point to which to connect; and
establish a connection with said access point thus selected.

11. Access point belonging to a short-range radio network identified by a network identifier, said network comprising a plurality of access points, the access point being capable of communicating with at least one station,
the access point comprising a processor configured to:
obtain at least one value of a connectivity parameter of a second access point from the plurality of access points; and
transmit, to the station, a message comprising the network identifier, and at least one value of the connectivity parameter of said second access point thus obtained.

12. A controller belonging to a short-range radio network identified by a network identifier, said network comprising a plurality of access points,
the controller comprising a processor configured to:
determine, for at least a first access point from the plurality of access points, a value of a connectivity parameter depending on at least one piece of information representative of at least one link established between said first access point and a second access point from the plurality of access points; and
transmit, to at least one of said access points from the plurality of access points, the value of the connectivity parameter of the first access point thus determined.

13. The controller according to claim 12, wherein the controller is embedded in said first access point of the network.

14. A non-transitory computer readable medium comprising a computer program product stored thereon comprising program code instructions for implementing the method according to claim 1, when this the program is executed respectively by the station.

15. A non-transitory computer readable medium comprising a computer program product stored thereon comprising program code instructions for implementing the method according to claim 6, when the program is executed respectively by the first access point.

16. The method according to claim 1, according to which the message further comprises an identifier of a second access point from the plurality of access points.

17. The method according to claim 5, wherein the message further comprises an identifier of a second access point from the plurality of access points.
